(19) United States
(12) Patent Application Publication
(10) Pub. No.: US 2012/0278262 A1
(43) Pub. Date: Nov. 1, 2012

(54) Suggesting Users for Interacting in Online Applications in a Social Networking Environment

(76) Inventors: Jared Morgenstern, Palo Alto, CA (US); Evgeny Kuzyakov, Izhevsk (RU)

(21) Appl. No.: 13/096,784

(22) Filed: Apr. 28, 2011

(51) Int. Cl. G06F 15/16; G06F 15/18

(52) U.S. Cl. 706/12; 709/206

(57) ABSTRACT

Users of a social networking system are matched with other users of the social networking system based on the likelihood of both users' being interested in using a social application and the likelihood that they would want to interact with each other using the application. Social applications include social games and other applications associated with a social networking system in which users can interact with other users. The social networking system selects for a particular user other candidate users. This selection may be based on at least one of a predicted likelihood that a user would invite the candidate users to use the social application and/or a predicted likelihood that the selected candidate user would accept the user's invitation. The user may choose to act on the suggestion by inviting the other user and the invited user may accept, reject, or ignore the invitation.

### BACKGROUND

This invention relates generally to social networking, and more specifically to matching users who are likely to interact with each other within social applications that use a social networking system platform.

Social networks, or social utilities that track and enable connections between users (including people, businesses, and other entities), have become prevalent in recent years. Additionally, the use of social networking systems to use social applications such as interactive games and other interactive applications has become commonplace. Social networking games, for example, provide several benefits and advantages to the users of the social networking systems. Users of the social networking system may enjoy playing a game with others in their social network, such as friends or friends of friends. Users who play games with friends may interact more with each other while playing the game, thereby increasing the user interaction and satisfaction from playing the game. Additionally, users playing with friends or other contacts within the social networking system may keep track of wins and losses over time, leading a more competitive or cooperative game play experience.

A user of a social networking system, however, often cannot leverage the social network to play games with others connected through the social network. For example, a user playing a game on a social network often is paired with another random user, generally not connected to the first user. Such a random pairing does not allow a social networking system to tap into the advantages outlined above.

In one instance, the social networking system can allow users to select friends from a list of the user's friends to play a game within the social networking system. For example, a user of the social networking system who wants to play a card game can invite the user's friends or contacts to play the game together. However, the user's friends or contacts may not want play a particular game with the user and may decline the user's invitation to play the game. A user can have a poor user experience if the user's requests to play the game are continually denied. Thus, a user may be reluctant to start any games in the future.

In another instance, the social networking system can randomly suggest the user's friends who have also indicated an interest in playing a game. However, in such an instance, the social networking system could suggest inappropriate friends or contacts to the user. For example, the social networking system might suggest a co-worker to play a game with the user, even though the user may have no interest in playing a particular game with a coworker. Additionally, such a method of suggesting users presupposes that all of the user's friends who want to play a particular game have already expressed an interest in playing the game. Often, users of social networking system may have an interest in a game but may not be aware of the game's existence. Thus, such a method of suggesting friends to the user is not very effective at matching users with friends.

### SUMMARY

Embodiments of the invention match users that are both likely to be interested in using a social application and likely to want to interact with each other using the social application. As such, the social networking system can suggest one or more candidate users to another user to use a social application, wherein the user can invite the candidate users to use the social application. Users who interact with each other using social applications are more likely to regularly use the social networking system and have a positive social networking experience. Similarly, social applications developers are more likely to develop and publish applications for a social networking system that provides a user base likely to interact with each other using the application.

In one embodiment, the social networking system selects one or more candidate users for a user and sends a suggestion to the user to invite the selected candidate users to interact with the user using a social application. This suggestion may be presented to the user within the user interface of the social application. If the user responds to the suggestion by inviting one or more of the candidate users, the social networking system sends an invitation to those candidate users on behalf of the user. The invitation may be presented within the user interface of the social application or via another communication channel, such as a messaging system of the social networking system. The invited candidate users may then accept, reject, or ignore the invitation based on whether they would like to interact with the inviting user within the social application.

In one embodiment, the social networking system selects the candidate users to suggest based on one or more of: (1) a predicted likelihood that the user would invite a candidate user to interact with using the social application responsive to a suggestion to send such an invitation, and (2) a predicted likelihood that the invited candidate user would accept the user's invitation to interact with the user using the social application. For example, the social networking system may predict the likelihood that a user would send an invitation to a candidate user responsive to a suggestion to do so based on social information tracked by the social networking system, such as the interactions between the users within the social networking system, the number of common friends or networks between the users, the users' previous history of inviting other users to interact using a social application, etc. Similarly, the social networking system may predict the likelihood that an invited candidate user would accept the user's invitation to use a social application based on social information such as the number of social applications used by the candidate user, the number of invitations the candidate user has accepted, the number of common interests between the users, etc.

In one embodiment, the social networking system suggests users for a social application that requires synchronous or asynchronous interaction. A synchronous social application requires that the two users interact with each other in real-time or roughly at the same time, which requires that both users be online at the same time. In one embodiment where the social networking system suggests users for a synchronous application, the social networking system selects the candidate users based on their online availability in addition to other factors mentioned herein. In contrast, an asynchronous application need not require real-time user interaction. For example, a user can interact with an application at any given time and the other user can respond to the interaction at any other time. In such an embodiment, the social networking system may ignore the users' availability to interact with each other at the same time.

The features and advantages described in this summary and the following detailed description are not all-inclusive. Many additional features and advantages will be apparent to one of ordinary skill in the art in view of the drawings, specification, and claims thereof.

### BRIEF DESCRIPTION OF THE DRAWINGS

FIG. 1 is a diagram of a system for matching users for that are both likely to be interested in using a social application and likely to want to interact with each other using the social application.

FIG. 2 is a network diagram of a system for matching users for that are both likely to be interested in using a social application and likely to want to interact with each other using the social application.

FIG. 3 is a block diagram of a social networking system, in accordance with an embodiment of the invention.

FIG. 4 is a flow chart of a process for matching users for that are both likely to be interested in using a social application and likely to want to interact with each other using the social application.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the system. In use, users join the social networking system and then add connections to a number of other users to whom they desire to be connected. In addition to interactions with other users, the social networking system provides users with the ability to take actions on various types of items supported by the system.

The social networking system also provides a platform for one or more social applications to operate, where the social applications receive information from the social networking system about the users and the connection between the users. A social application may provide a variety of features that allow its users to interact with other users, such as a social networking game. Other examples of social applications include, but are not limited to, news applications, photo/video sharing applications, text or video messaging applications and web access applications. Social applications may be provided by the same operator as the social networking system, or it may be provided by a third party. As described in greater detail below, the social applications can be accessed by users using a computer, a mobile computing device, a gaming console, etc. In one embodiment, the social networking system matches users who are both likely to be interested in using a social application and likely to want to interact with each other using that social application. In this way, the use of the social application itself and the interactions among users of the social networking system are both encouraged.

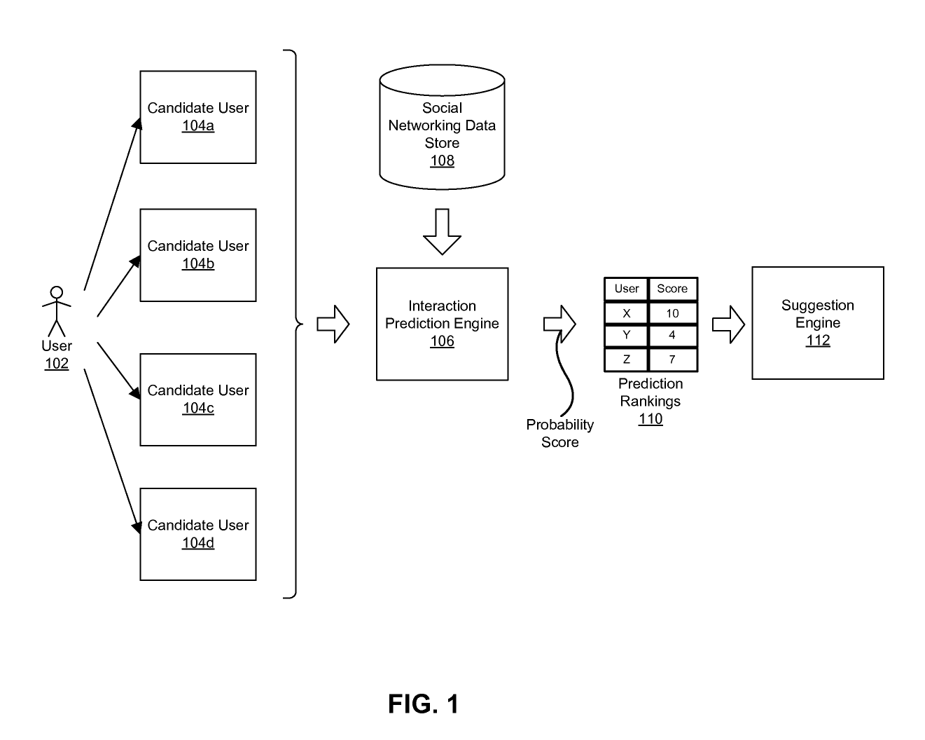

FIG. 1 illustrates a system for matching users for a social application, in accordance with an embodiment of the invention. FIG.1 illustrates a user 102, the user's friends 104, a prediction engine 106, social networking data store 108 and a table 110 illustrating probability scores assigned to each friend of the user.

In one embodiment, the social networking system matches a user to other users when the user indicates that he/she would like the social networking system to make a user suggestion. In such an instance, the social networking system may request a user to provide information on types of other users the user would like to interact with. In other embodiments, the social networking system automatically matches users to others.

In one embodiment, the social networking system matches users based on criteria provided by the user. A user may indicate that he/she would like to interact with a friend or a connection within the social networking system. For example, a user may be connected to others as friends within the social networking system or may be part of a group or a social network within the social networking system. In such an instance, the social networking system matches the users with others who are friends with the user or are in same social networks as the user. In other instances, the user may request to be connected to others who have interacted with the user using a social networking system application, users who share common interests with the user or have similar level of expertise or experience in using the application.

In one embodiment, the social networking system retrieves social networking information about a user 102 associated with a social application. A user 102 can associate with a social application by, for example, using the application, viewing the application, clicking on an instance of the social application, etc. In an embodiment wherein the user provides that he/she would like to interact with friends or connections of the user to use the social application, the social networking system identifies a plurality of other users 104 of the social networking system who are connected to the user. Users of a social networking system can be connected as friends, as part of one or more social networks, as friends of friends etc. Users connected to each other in a social networking system are also referred to as friends 104 herein. In another embodiment, the social networking system can identify any other users of the social networking system regardless of whether the users are expressly connected to the user 102 associated with the social application. In such an instance, other users can include users who may not be connected to the user, but have used a social networking application with the user or share common interests with the user.

For each of a number of identified other users, a prediction engine 106 predicts a likelihood that the user 102 and the friend 104 will interact in the social application. In one embodiment, the prediction engine 106 retrieves social networking information for the user 102 and each one of the friends 104 to identify a probability that the user 102 will invite the friend 104 to interact using the social application. For example, the prediction engine 106 can assign a higher probability if the user 102 and the friend 104 have had several interactions in a social application, several interests in common, etc. In one embodiment, the prediction engine 106 uses a machine learning algorithm to assign a probability based on historical social networking data and interaction information between the user 102 and the friend 104. In one embodiment, the prediction engine 106 predicts a likelihood that the friend 104 will accept a user's 102 invitation to interact in a social application. The prediction engine 106 can retrieve data from the social networking data store 108 for each friend 104 to be suggested and the user 102, such as interaction information between the users, the number and type of interactions between the users, the number of common friends and networks, etc. In an embodiment, the prediction engine 106 uses a machine learning algorithm to calculate the probability that the friend 104 will accept the user's 102 invitation to use a social application. The prediction engine assigns a probability score to each friend 104.

In one embodiment, the social networking system ranks 110 each friend 104 based on the likelihood of a user inviting the candidate user to use a social application, the likelihood of the candidate user accepting the user's invitation or both. In one embodiment, the social networking system suggests the top ranked friends 104 to the user, wherein the user can invite the suggested friends 104 to use a social application. In an embodiment, wherein the social application requires synchronous interaction, the social networking system suggests the top ranked users based on the prediction rankings 110 who are also available for synchronous interaction. In another embodiment, wherein the social application requires synchronous interaction and a user specifies a future date and time of interaction, the social networking system suggests top ranked users who have also indicated a similar date and time of interaction to use the social application. In yet another embodiment, the social networking system suggests a candidate user and an application to the user wherein the other user is using the application at the time of the suggestion. For example, if another user is playing a social application such as a game that requires synchronous use by two or more users, the social networking system suggests the other user and the application to the user if the user is likely to play the game with the other user and the other user is likely to play the game with the user. In such an instance, the user may be provided with a link allowing the user to join the other user in playing the game or using the social application.

### System Architecture

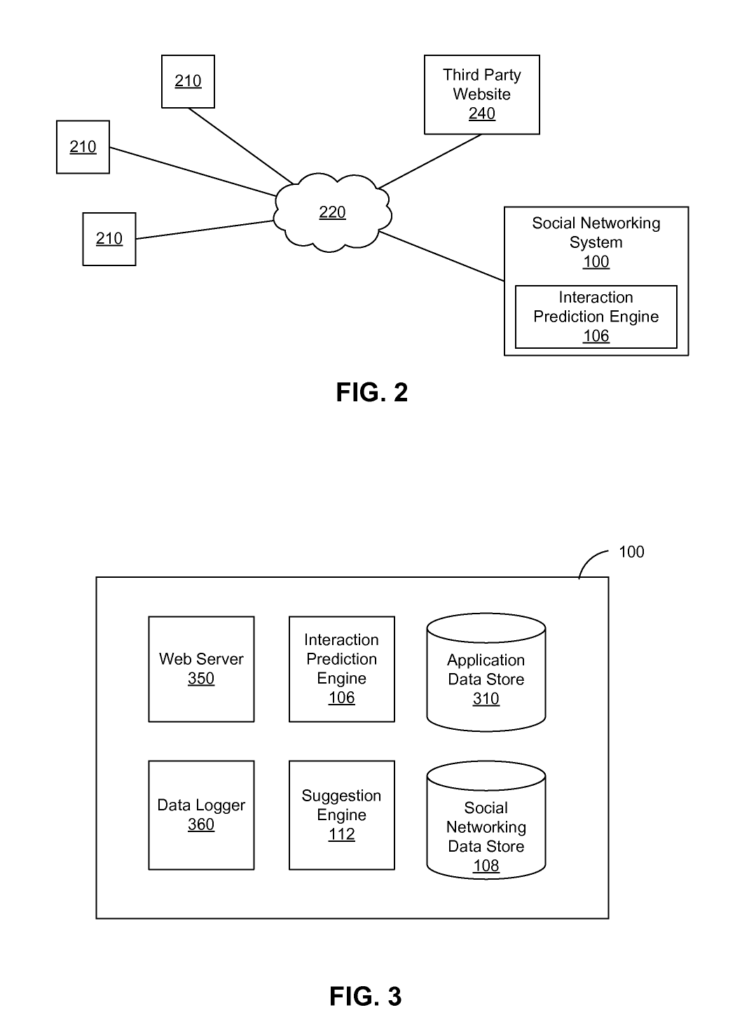

FIG. 2 is a high level block diagram illustrating a system environment suitable for operation of a social networking system 100. The system environment comprises one or more client devices 210, one or more third-party websites 240, a social networking system 100 and a network 220. In alternative configurations, different and/or additional modules can be included in the system.

The client devices 210 comprise one or more computing devices that can receive member input and can transmit and receive data via the network 220. For example, the client devices 210 may be desktop computers, laptop computers, tablet computers (pads), smart phones, personal digital assistants (PDAs), video gaming consoles or any other device including computing functionality and data communication capabilities. The client devices 220 are configured to communicate via network 220, which may comprise any combination of local area and/or wide area networks, using both wired and wireless communication systems. The third party website 240 can be coupled to the network 220 for communicating messages to the social networking system 100 about the users' actions off the system 100.

The social networking system 100 comprises a computing system that allows users to communicate or otherwise interact with each other and access content as described herein. In one embodiment, the social networking system 100 stores member profiles that describe the users of a social network, including biographic, demographic, and other types of descriptive information, such as work experience, educational history, hobbies or preferences, location, and the like.

FIG. 3 is a block diagram of an embodiment of a social networking system 100. The social networking system 100 includes a web server 350, a data logger 360, a social networking data store 108, an interaction prediction engine 106, an application data store 310 and a suggestion engine 320. In other embodiments, the social networking system 100 may include additional, fewer, or different modules for various applications.

The web server 350 links the social networking system 100 via the network 220 to one or more client devices 210, as well as to one or more third party websites 140. The web server 350 may include a mail server or other messaging functionality for receiving and routing messages between the social networking system 100 and the client devices 210 or third party websites 140. The messages can be instant messages, queued messages (e.g., email), text and SMS messages, or any other suitable messaging technique.

The data logger 360 is capable of receiving communications from the web server 350 about member actions on and/or off the social networking system 100. The data logger 360 populates the social networking data store 108 with information about these member actions and communications tracked throughout the social networking system. As discussed above, the social networking system 100 maintains data about a number of different types of objects with which a member may interact on the system 100. To this end, the social networking data store 108 stores data structures to manage data for each instance of the corresponding type of object maintained by the system 100. The data structures comprise information fields that are suitable for the corresponding type of data. (For example, event data structures can include the time and location for an event, whereas the member profile data structures can include fields suitable for describing a member's profile.) When a new object of a particular type is created, the system 100 initializes a new data structure of the corresponding type, assigns a unique object identifier to it, and begins to add data to the object as needed. This might occur, for example, when a member defines a new event, wherein the system 100 would generate a new instance of an event in the social networking data store 108, assign a unique identifier to the event, and begin to populate the fields of the event with information provided by the member.

In one embodiment, the application data store 310 includes information about one or more applications associated with the social networking system. For example, a social game can be associated with a social networking system if its made available to users of the social networking system. Game information can include meta-data; for example, a game developer can provide that a game is of a particular type of game, such as: action, adventure, racing, role-play, board game, etc. The game-developer can also specify the cost of playing the game, the length of game-play time, whether the game must be played synchronously or can be played asynchronously, the pace of play, the number of players associated with the game, etc. Game information can also include reviews associated with a game, user provided comments about the game or the genre of games.

In one embodiment, the application data store 310 includes data associated with every application or a game a user has played. In another embodiment, the application data store 310 can include data for every game associated with the social networking system. The game-play prediction engine can use, for example, the game data for each game played by the user in generating a training data set to identify a machine learned algorithm. In another instance, the interaction prediction engine 106 can compute the probability of a user and a user's friend playing a game for each game associated with the social networking system regardless of whether the user has played the game or has indicated an interest in playing the game.

The interaction prediction engine 106 match users that are both likely to be interested in using a social application and likely to want to interact with each other using the social application. For example, the interaction prediction engine 106 can match users based on predicted likelihood that a user will invite a candidate user to interact with using the social application, the predicted likelihood that the candidate user will accept the user's invitation to use the social application or both.

In one embodiment, the interaction prediction engine 106 computes the probability that a particular user will respond to a suggestion to invite another user to interact with the user using a social application associated with the social networking system. For example, the interaction prediction engine 106 can assign a probability score to a friend 104 based on the number of prior interactions between the users, the number of those interactions initiated by the user 102, the amount of time elapsed between communications, the type of communications, such as wall posts, email messages, photo tags, interaction on a group object, the number of friends or social networks in common, etc. In one embodiment, the social networking system uses a machine learning model to calculate the probability of a user 102 inviting a friend 104 to use a social application associated with the social networking system. For example, the interaction prediction engine 106 can retrieve historical social networking data of other users of the social networking system. The interaction prediction engine 106 can compute a machine learned algorithm based on a number of variable or characteristics mentioned above and indicated by the historical data, wherein the machine learned algorithm can be used to compute the probability of a user 102 inviting a friend 104 to use a social application. In an alternate embodiment, wherein the social networking system suggests a social application and friends 104 to a user, the interaction prediction engine 106 computes the probability of a user 102 using an application based on the a priori assumptions or historical data available in the social networking system as discussed above.

In one embodiment, the social networking system computes a likelihood that the invited candidate user 104 would accept the user's 102 invitation to use a social application. The interaction computation engine 106 can assign a probability score to each candidate user 104 based on whether the candidate user 104 uses the social application, the type of social applications currently being used by the user 102 and similarities between the application to be included in a user 102 suggestion and social applications most often used by the candidate user 104, etc. In another embodiment, the interaction computation engine 106 uses a machine learning model to compute the probability of the candidate user 104 accepting the user's 102 invitation to use a social application. As described above, the machine learning model uses historical social networking data of other users of the social networking data, who for example, have accepted invitation to use the social application. The machine learning model can use several data points within the historical data as variables to generate a predictive algorithm. For example, variables such as friends belonging to the a “Poker Strategies” group on the social networking system, joining the group at about the same time and using the word “poker” in communication can be indicative of a high likelihood of a candidate user 104 accepting a user's invitation to play a social game. In addition, other data points such as the number of invitations accepted by the candidate user, the number of times the candidate user has clicked on a display of the social application can indicate a likelihood that a candidate user 104 will accept a user's 102 invitation to use a social application. As described above, the game play prediction engine 180 uses historical data stored in the social networking data store 108 to compute the probability of a candidate user 104 accepting the user's invitation to interact in a social application.

In one embodiment, the interaction prediction engine 106 assigns a probability score to each candidate user 104 based on the predicted likelihood that a user will respond to a suggestion to invite a candidate user 104 to interact with using the social application, the predicted likelihood that the candidate user will accept the user's invitation to use the social application or both. In one embodiment, the social networking system ranks users 104 based on the probability score, wherein the highest ranked users can receive the highest rankings

In one embodiment, the suggestion engine 112 suggests candidate users 104 to the user based on the rankings received by each candidate user. For example, candidate users with the highest rankings can be suggested to the user before users with lower rankings In an embodiment where the game requires synchronous play, the suggestion engine 112 does not suggest the ranked candidate users who are not online at the same time as the user. Thus, only the highest ranked candidate users who are online or are available to interact at the same time as the user are suggested to the user based the rank received by each candidate user.

Method of Ranking Candidate Users according to an Affinity Score

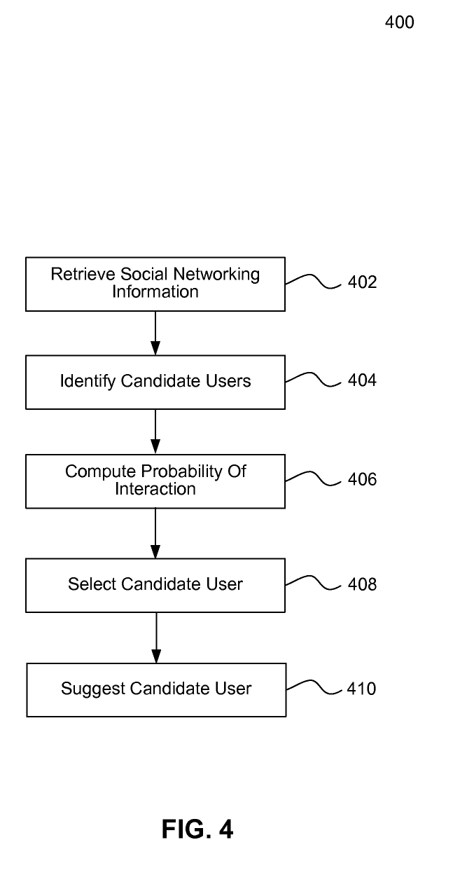

FIG. 4 illustrates an embodiment of a process 400 for matching users for that are both likely to be interested in using a social application and likely to want to interact with each other using the social application. In one embodiment, the social networking system retrieves 402 social networking information for a user to initiate the process for matching the user with other candidate users to interact via a social application. The social networking system can retrieve user information responsive to a user request to suggest candidate users who would be interested in using the social application with the user. In another embodiment, the social networking system retrieves social networking information for each user who accesses an interactive social application.

In one embodiment, the process identifies 404 other users of the social networking system as candidate users. In one embodiment, the social process identifies all other users of the social networking system as candidate users. In another embodiment, the process identifies friends, friend of friends or users in the same social network as the user as candidate users.

The process computes 406 the likelihood that a user will invite a candidate user to interact with using the social application, the likelihood that the candidate user will accept the user's invitation to use the social application or both. In one embodiment, the process 406 computes the probability of a user inviting a candidate user 104 to interact with in a social application by looking at the social networking data between the users. For example, the process can assign a higher probability of invitation to users who interact with each other daily, who are part of the same social networks, have several common friends, interact with each other in other social application etc. In another embodiment, the process computes 406 a probability of a user sending an invitation to a candidate user 104 based on the machine learning methodology. The process can compute a machine learned algorithm based on historical data of other social networking users who have sent invitations to others users to use the social application or similar application. The process can then use the machine learned algorithm and the social networking data between the two users to compute 406 the probability of the user sending to a candidate user.

In another embodiment, the process computes 406 the probability that the candidate user 104 would accept an invitation from the user to interact in the social application. The process can assign a probability score based to each candidate user based on the interaction data and other social networking data available in the social networking system. For example, a candidate user who has accepted several invitations from the user to interact in other social applications is assigned a higher probability score than a candidate user who has not accepted any user invitations. In another embodiment, the process can use a machine learning methodology to predict a probability of each candidate user accepting the user's invitation to interact in the social application. As described above, the process uses historical data of other users who have accepted invitations to interact in a social application to compute a machine learned algorithm. The process computes 406 a probability score based on the machine learned algorithm and social networking data associated with the user and each candidate user.

In one embodiment, the process ranks the candidate users 104 based on their probability scores. The rankings can be computed from the likelihood of the users to send an invitation to the candidate user, the likelihood of the candidate user to accept the invitation or both. The process selects 408 the highest ranked candidate user to suggest to the user to send an invitation to interact in the social application. In an embodiment, wherein the social application requires synchronous interaction, the process selects 408 the highest ranked candidate user who is online or available at the same time as the user.

In one embodiment, the process suggests 410 the selected candidate user to the user of the social networking system, wherein the user can act on the suggestion an invite the selected candidate user to use the social application. If the user acts on the suggestions, the social networking system receives a request to send an invitation from the user to the selected candidate user 104. The social networking system routes the invitation to the candidate user wherein the candidate user can accept or ignore the invitation. The social networking system can connect the two users within the social application if the candidate user accepts the user's invitation. In another embodiment, the social networking system provides the users' information to the social application developer, wherein the developer can connect the users within the social application.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible, non-transitory computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for matching users for a social application, the method comprising:
retrieving social networking information about a user of a social networking system who uses a social application, the social application allowing users of a social networking system to interact using the social application;
identifying one or more other users of the social networking system;
selecting one or more candidate users from the identified users based on a likelihood that the user and the selected candidate user would interact in the social application;
sending invitations to the one or more selected candidate users to interact with the user in the social application.

2. The method of claim 1, wherein the one or more other users are identified based on user provided criteria.

3. The method of claim 1, wherein the candidate users are selected based at least in part on a predicted likelihood that the user would invite a candidate user to interact with using the social application responsive to a suggestion to invite the selected candidate user.

4. The method of claim 1, wherein a machine learning process is used to predict the likelihood that the user and other user will interact in the social application.

5. The method of claim 1, wherein the candidate users are selected based at least in part on a predicted likelihood that the selected candidate user would accept an invitation from the user to interact with the user using the social application.

6. The method of claim 1, wherein user suggestions are sent within the social application.

7. The method of claim 1, comprising sending a suggestion to the user to invite the selected candidate users to interact with the user in the social networking application.

8. The method of claim 7, further comprising:
receiving a request from the user to invite an identified candidate user; and
sending an invitation to the identified candidate user to interact with the user in the social application.

9. The method of claim 1, wherein the invitations are sent in a communications channel of the social networking system.

10. The method of claim 1, further comprising suggesting others to the user who are online at the same time as the user, wherein the social application requires the users to be online at the same time to communicate using the application.

11. The method of claim 1, further comprising suggesting another user and a social application to the user, wherein the other user is using the social application at the time of the suggestion.

12. A method for matching users for a social application, the method comprising:
retrieving social networking information about a user of a social networking system who uses a social application, the social application allowing users of a social networking system to interact using the social application;
identifying a plurality of other users of the social networking system who are connected to the user;
for each of a number of the identified other users, predicting a likelihood that the user and the other user will interact with each other within the social application;
selecting one or more of the other users based on the predicted likelihood; and
suggesting to the user to invite one or more of the selected other users to use the social application.

13. The method of claim 12, wherein the social application in an interactive game.

14. The method of claim 12, further comprising:
receiving a request from the user to invite one or more of the other users to use the social application; and
sending an invitation to use the social application from the user to the one or more other users.

15. The method of claim 12, wherein the one or more other users are identified based on user provided criteria.

16. The method of claim 12, wherein the prediction is made based on at least one of the likelihood that the user will request an invitation to one or more of the other users and the likelihood that each of a number of the identified other users will accept an invitation from the user to use the social application.

17. The method of claim 12, wherein a machine learning process is used to predict the likelihood that the user and other user will interact in the social application.

18. The method of claim 12, wherein the social networking system provides the selected user based on the predicted likelihood that the user and other user will interact in the social application to an external system.

19. The method of claim 18, wherein at least one of an external system or the social networking system provides the social application.

20. The method of claim 12, wherein the social application is synchronous.

21. The method of claim 20, wherein the selection of the user is further based on whether the one or more other users are available online at the same time as the user.

22. The method of claim 12, further comprising suggesting another user and a social application to the user, wherein the other user is using the social application at the time of the suggestion.
